(19) United States
(12) Patent Application Publication
(10) Pub. No.: US 2007/0254673 A1
(43) Pub. Date: Nov. 1, 2007

(54) Method and System of Positioning

(76) Inventors: Per Anders Stenberg, Sollentuna (SE); Mikael Bergenlid, Sollentuna (SE); Johan Alteir-Tuvesson, Karlskrona (SE)

Correspondence Address: ERICSSON INC., 6300 LEGACY DRIVE, M/S EVR 1-C-11, PLANO, TX, 75024, US

(21) Appl. No.: 10/595,137

(22) PCT Filed: Sep. 3, 2003
(86) PCT No.: PCT/SE03/01367

§ 371 Date: Mar. 16, 2007

(51) Int. Cl. G01S 5/14

(52) U.S. Cl. 455/456.1

(57) ABSTRACT

The present invention relates to cellular mobile radio systems, particularly to systems of more than one co-sited cell/sector. A method and apparatus of satellite assistance for high accuracy positioning not requiring more terrestrial radio sites than one to be involved in positioning is disclosed.

### TECHNICAL FIELD OF THE INVENTION

The present invention relates to cellular mobile radio systems, particularly to positioning in such systems.

### BACKGROUND AND DESCRIPTION OF RELATED ART

Positioning of, e.g., mobile stations making use of inherent information such as received transmission power level is previously known. It is also considered known in prior art to make use of such information from different base stations receiving signals transmitted from the example mobile station for increasing accuracy of the positioning, e.g. by means of triangulation.

There is an increasing demand for positioning from various administrations. Positioning is particularly requested for emergency calls. Accuracy and time to first fix are key parameters in positioning.

For GSM and UMTS there are two methods of positioning of consideration:
1. Cell Global Identity with Timing Advance.
2. Assisted GPS.

Cell Global Identity with Timing Advance is operable with GSM. It makes use of a Cell Global Identity broadcast from each base station. The Cell Global Identity consequently identifies the base station with which the mobile station is communicating, or the cell on which the mobile station is camping. The distance from the base station is determined by means of a system inherent Timing Advance parameter, compensating for propagation delay time between base station and mobile station. Conclusively, with Cell Global Identity with Timing Advance the mobile station can be determined to be within a ring-shaped or arc-shaped area within a cell or cell sector, depending on the radiation pattern. FIG. 1 illustrates positioning with timing advance for a 1200 sector cell with base station <<Site>> located to a cell <<Cell/Sector>> corner. A mobile station <<MS>> is located to a TA band <<TA Band>> of width equal to the inaccuracy of the timing advance. However, the method does not reveal where within this band the mobile station is located unless more base stations are involved in positioning. I.e. the mobile station <<MS>> could be anywhere in the shaded area <<TA Band>> with the same outcome when trying to position it. In UMTS a feature corresponding to Cell Global Identity with Timing Advance is named Cell Identity with Round Trip Time.

Assisted GPS is a satellite positioning system for assisting both GSM and UMTS, as well as optionally other terrestrial radio systems, but requires a GPS (Global Positioning System) receiver and additional signaling and is not compatible with old GSM terminals. A basic assisted GPS system is illustrated in FIG. 2. GPS position information is received from three satellites <<Sat1>>, <<Sat2>>, <<Sat3>>. To reduce time to first fix, GPS positioning is assisted by coarse terrestrial positioning communicated from base station <<Site>>. Basically, there are two modes of assisted operation, mobile assisted and mobile based. In the former mode, the mobile station determines pseudoranges to the satellites <<Sat1>>, <<Sat2>>, <<Sat3>> in view as determined from the coarse positioning. The pseudoranges are transferred to the terrestrial network, in which the mobile station position is calculated. In the latter mode of assisted operation, the mobile station determines its position from available data.

U.S. Pat. No. 6,321,083 discloses a method and arrangement for locating telephone traffic hot spot of a cell. Timing advance informs of mobile station distance from base station with which it is connected. Direction to the mobile station is determined by means of signal strength from two or more adjacent cells.

International Patent Application WO9728456 describes a terminal position location method using received power levels of multiple neighbor beams from an array antenna.

None of the cited documents above discloses co-sited neighbor assisted positioning determining distance between mobile station and base station by means of timing advance and determining mobile station bearing from received signal level and signal level received in a co-sited neighbor cell/sector, where preferably determined positions are stored for various signal level ranges.

### SUMMARY OF THE INVENTION

With greater precision there is less ambiguity and services can be focused. Positioning is particularly requested for emergency calls, but for investments to pay off there will most certainly also be other positioning applications. Cell Global Identity with Timing Advance is considered to be too imprecise to attract operators to most such applications.

Time required for determining mobile station position should be as short as possible. Extensive signaling would drain batteries and load both radio interface, between mobile station and base station, and radio access network/core network. Further, to attract operators, the method should be applicable to existing mobile stations.

There is a problem in existing terrestrial positioning methods utilizing propagation time delay, such as E-OTD (Enhanced Observed Time Difference) or O-TDOA (Observed Time Difference of Arrival), requiring communication involving more than one site for, e.g., triangulation as this among other things involves increased signaling for exchange of timing information for determining propagation time delay. Neighboring base stations may also be under control of different base station controllers, BSCs, or radio network controllers, RNCs. Extensive signaling also delays positioning. Upgrading of existing mobile stations may also be required.

A problem of terrestrial positioning methods utilizing received signal levels, requiring communication involving more than one site for, e.g., triangulation is the small correlation of propagation path losses between different sites, rendering the distance estimates less reliable.

It is consequently an object of the present invention to enhance existing positioning methods for increased accuracy.

It is also an object to achieve a system of terrestrial positioning not requiring more than one terrestrial radio site for fast and reliable positioning.

An object is also not to require extensive operator measuring activities for achieving the enhancement.

A further object is not to require more than one co-sited neighboring cell/sector, assisting the serving cell/sector, for positioning.

Another object is to determine mobile station positions without additional signaling draining batteries.

Finally, it is an object to have an enhanced method and system of positioning compatible with existing mobile stations.

These objects are met by a method and system determining a narrow sector segment within which the mobile station is most likely located according to received signal level and co-sited neighbor cell/sector received signal level, where the signal levels are set in relation to stored positions as determined for corresponding signal levels. With timing advance in addition a position can be determined accurately without involving more than a single site.

### BRIEF DESCRIPTION OF THE DRAWINGS

FIG. 1 illustrates positioning with timing advance for a 120° sector cell with base station <<Site>> located to a cell <<Cell/Sector>> corner according to prior art.

FIG. 2 displays a basic assisted GPS system according to prior art.

FIG. 3 illustrates a non-exclusive example dynamic table for table lookup according to the invention.

FIG. 4 schematically illustrates the cell/sector azimuth as described in relation to FIG. 3.

FIG. 5 illustrates ECGI with stored positions in relation to received signal levels according to the invention.

FIG. 6 schematically illustrates at least one BTS connected to a BSC over an Abis interface.

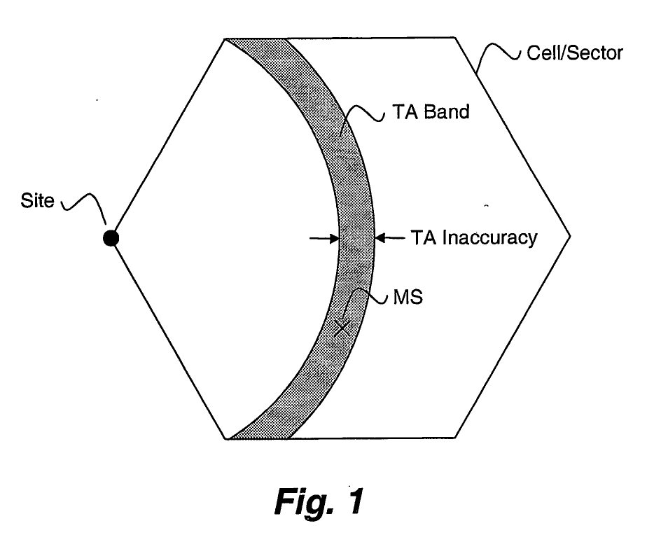

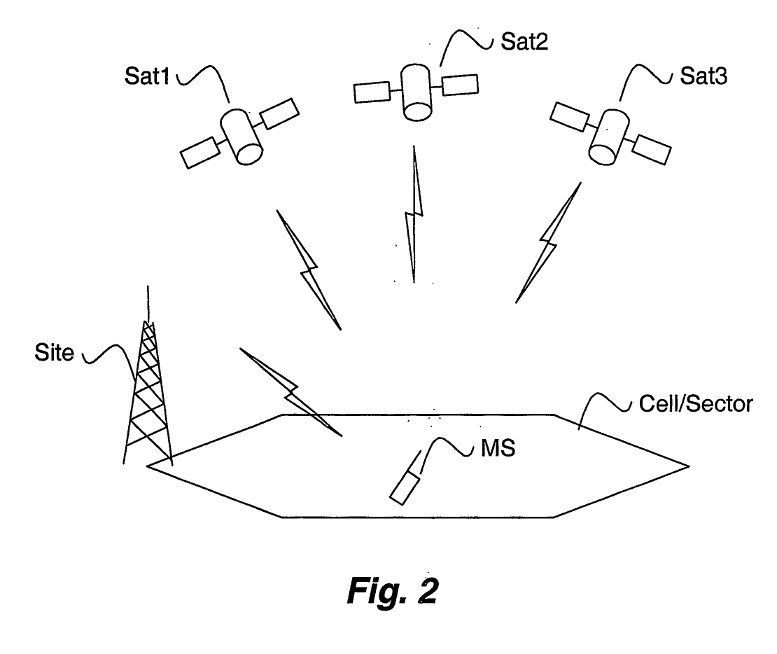

### DESCRIPTION OF PREFERRED EMBODIMENTS

It has been observed that propagation path losses of neighboring cells/sectors of the same site are highly correlated, particularly for propagation paths between the site and mobile stations close to cell/sector border. In an Enhanced Cell Global Identity, ECGI, method and system, preferably with timing advance, the position is enhanced by determining a sector segment within which the mobile station is most likely located according to received signal level and a co-sited neighbor received signal level. With timing advance in addition, an accurate position can be determined without involving more than one site. The positioning precision is improved by storing positions of mobile stations in relation to various signal level intervals. Preferably, the positions for each signal level are received from mobile stations of recent releases including means for complementary or assisting positioning, such as GPS receivers for A-GPS enabled phones.

Preferably bearings from the site to the mobile station, where a bearing is determined for each GPS position, are averaged over various intervals of received signal levels of serving cell/sector or cell/sector where the mobile station is camping and at least one neighboring cell/sector.

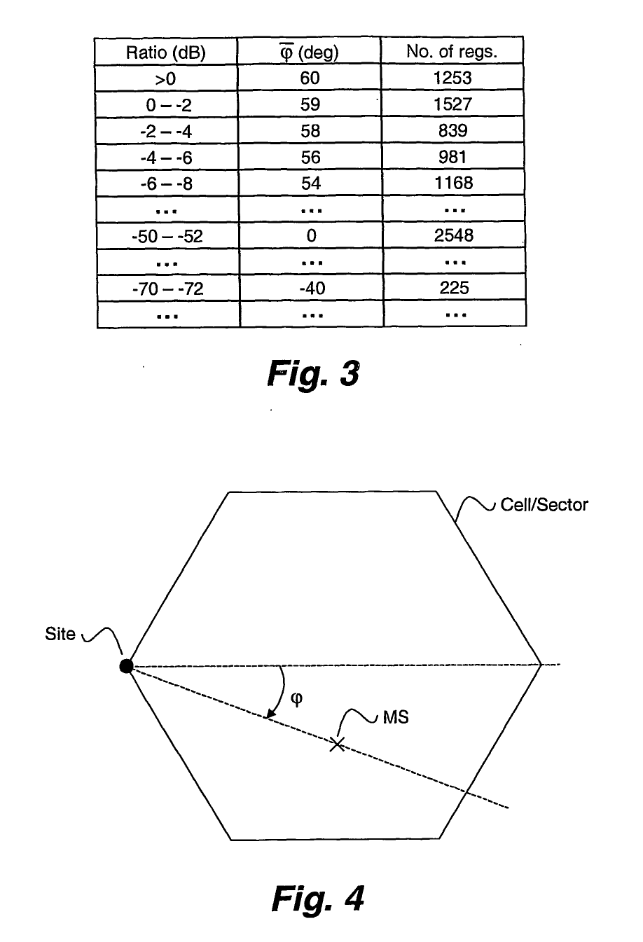

A non-exclusive example dynamic table for table lookup is illustrated in FIG. 3. In the example dynamic table, the received signal ratio is quantized in equal sized intervals. However, the invention also covers signal level ratio intervals of unequal sizes. For each illustrated interval there is a number of registrations forming basis for an azimuth average << φ̅>>, as determined from respective GPS positions stored together with the azimuth average << φ̅>>. The azimuth averages << φ̅>> are updated for new registrations matching the signal level ratio intervals, respectively. For reasons of simplicity the table is illustrated with only one parameter: the signal ratio interval. More than one signal level ratio can be used as described above, and also other parameters than signal level ratio can be made use of.

FIG. 4 schematically illustrates the cell/sector angles as described in relation to FIG. 3.

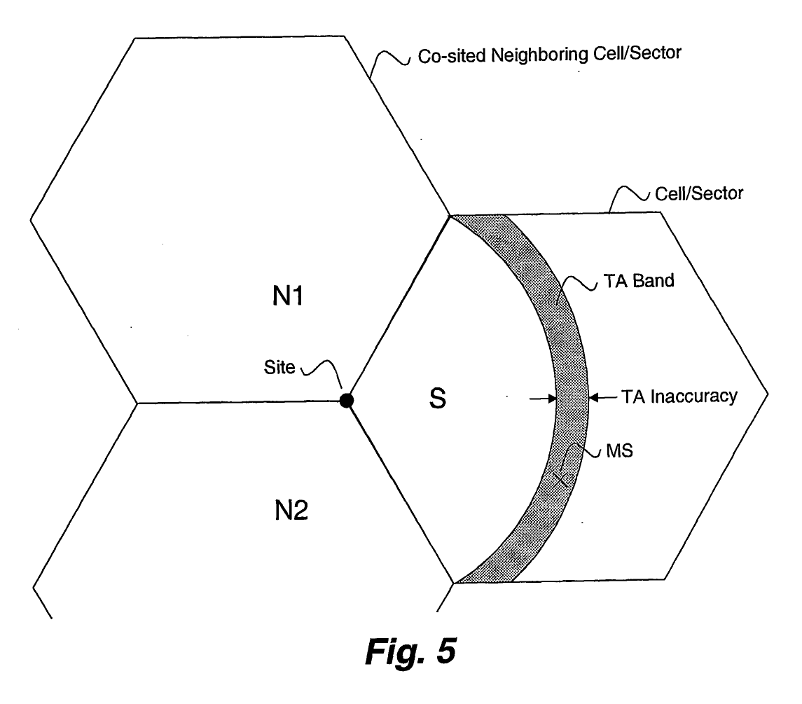

FIG. 5 illustrates ECGI with complementary or assisting positioning according to the invention. The mobile station continuously performs measurements of received signal strength of neighboring cells (or base stations) for handover purposes. According to prior art specifications, a list of such one or more cells should be transferred to the network for handover control.

The ratio of respective received power in a neighboring cell/sector <<N1>> and a serving cell/sector <<S>> determines where on the TA band <<TA Band>> a mobile station is located. For a given TA band, the direction to the mobile station <<MS>> is determined from a ratio of respective received power in a neighboring cell/sector <<N1>> and a serving cell/sector <<S>>. This ratio is used for table look-up in a position table of Serving Mobile Location Center <<SMLC>>, where averaged angular directions are stored for various intervals of signal level ratios. A second ratio can be determined for an additional co-sited neighboring cell <<N2>> to be combined with the initially determined ratio to increase accuracy. If there are more than three sectors of the site, corresponding ratios can be determined also for additional number of co-sited neighbors to be included. Quantities other than signal level ratios can also be included as parameters.

As location is determined from power ratios (or differences in dB-scale) according to the invention, absolute references from field test measurements are not required. The high correlation between propagation path losses of different cells/sectors of the same site, particularly for mobile stations close to cell/sector borders, further relaxes the need of field test measurements.

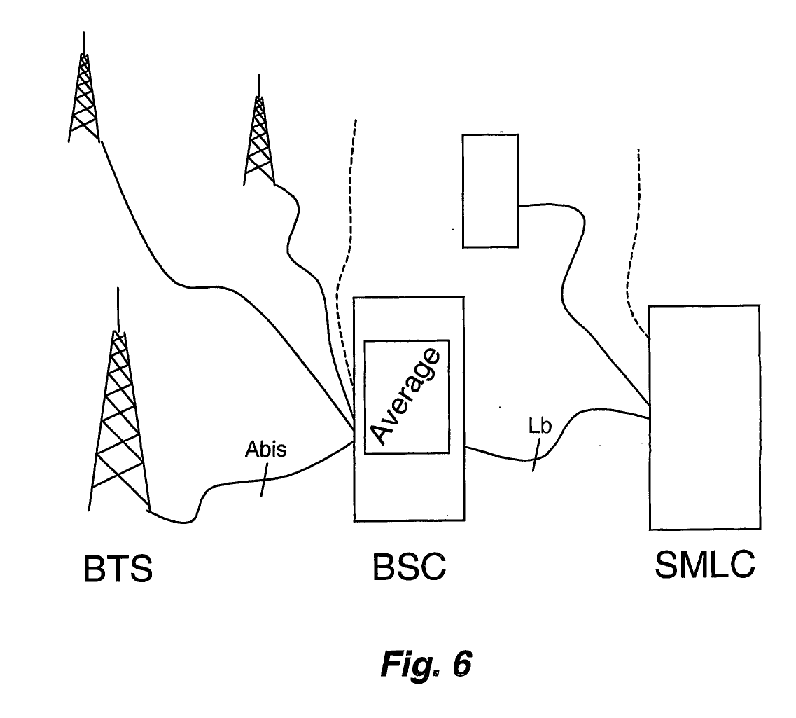

FIG. 6 schematically illustrates at least one Base Transceiver System <<BTS>> connected to a BSC (Base Station Controller) <<BSC>> over an Abis interface <<Abis>>. The Base Station Controller is connected to an SMLC (Serving Mobile Location Center) <<SMLC>> over an Lb interface <<Lb>>. The SMLC can be integrated in BSC or MSC or be a standalone device. In the latter two cases also other base station controllers are connected to the SMLC in most implementations.

In a preferred mode of the invention, for a Mobile Station to be positioned received signal levels from the base transceiver system <<BTS>> are averaged in a locating function of base station controller <<BSC>>. The signal levels delivered to SMLC thereby become less noisy and more stable. Further, excessive transmissions in the fixed network are avoided by averaging early in the transmission chain from BTS to SMLC. In, e.g., GSM the earliest feasible occurrence of averaging with sufficient processing capacity is the base station controller. A further advantage is that Abis interface is only marginally additionally loaded as compared to a system not providing for the invention as signal levels, not being averaged, are made available in BSC according to prior art specifications. Preferably the average levels are determined in a locating function of BSC. In addition to prior art systems, base transceiver station <<BTS>> transmits two signaling levels, one of the served cell and one of the neighbor, in place of only one. Optionally, signaling levels of more than one neighbor cell signaling level (and consequently more than two signaling levels) are transmitted. If signaling levels of both neighbors are included, bearing can be determined from a radio/difference of the individual ratios/differences or directly from a ratio/difference of neighbor signal levels. The base station includes the received signal level of the served cell/sector and at least one co-sited neighboring cell/sector. Preferably, the cell or cells to be included are selected from those signal levels of co-sited cell or cells highest ranked in the locating function. No averaging in SMLC would be required. Further, a requirement on averaging in SMLC would violate present GSM-standardization.

In one realization of the invention signal levels from a mobile station of up to 32 neighbor cells/sectors can be averaged.

When the invention is applied to e.g. GSM, the averaged level is preferably included in a BSSLAP TA Response to SMLC in response to a BSSLAP TA Request. Thereby, signaling load in the Lb, or corresponding, interface would be reduced, and there would be less noise in the resulting position estimate.

A person skilled in the art readily understands that the receiver and transmitter properties of a BTS or an MS are general in nature. The use of concepts such as BTS, BSC, MSC, SMLC or MS within this patent application is not intended to limit the invention only to devices associated with these acronyms. It concerns all devices operating correspondingly, or being obvious to adapt thereto by a person skilled in the art, in relation to the invention. As an explicit non-exclusive example the invention relates to Base Station Controllers of GSM as well as Radio Network Controllers, RNCs, of UMTS.

The invention is not intended to be limited only to the embodiments described in detail above. Changes and modifications may be made without departing from the invention. It covers all modifications within the scope of the following claims.

1. A method of positioning a radio transmitter comprising
determining distance to a receiver of known position according to a parameter reflecting propagation delay time and
determining direction from the receiver to the transmitter from a respective at least one parameter reflecting received signal level in a cell/sector where the transmitter is camping or being served and signal level in a co-sited cell/sector, the parameter determining direction from stored assisting position data.

2. The method according to claim 1, wherein the assisting position data is classified in intervals of one or more parameters.

3. The method according to claim 2 wherein the position data in each interval is averaged over the interval of each of the one or more parameters.

4. The method according to claim 3 wherein the one or more parameters include received signal level.

5. The method according to claim 3 wherein the one or more parameters include timing advance.

6. The method according to claim 3 wherein the stored assisting position data is average position data.

7. The method according to claim 1 wherein the assisting position data is GPS or other satellite positioning system position data.

8. The method according to claim 7 further comprising, receiving the assisting position data from one or more of a plurality of subscriber receivers in a public mobile radio communication system.

9. The method according to claim 1 wherein the co-sited cell/sector is at least one of the cells/sectors being immediate neighbors of the cell where the transmitter is camping or being served.

10. The method according to claim 1 wherein direction to the transmitter is determined by forming a linear scale ratio of or dB-scale difference between the neighbor cell/sector received level and received level of the cell/sector where the transmitter is camping or being served.

11. The method according to claim 1 wherein determination of transmitter positioning includes cell/sector identity.

12. The method according to claim 1 wherein the received signal level is averaged prior to forming a basis for positioning.

13. The method according to claim 12 wherein the average is formed in a network control element.

14. The method according to claim 13 wherein the network control element is an entity most closely connected to the receiver entity over a standardized interface.

15. The method according to claim 14 wherein the entity most closely connected to the receiver is a base station controller.

16. The method according to claim 14 wherein the entity most closely connected to the receiver is a radio network controller.

17. A device for positioning a radio transmitter comprising:
processing means for determining:
distance to a receiver of known position according to at least one parameter reflecting propagation delay time:
direction from the receiver to the transmitter from a respective parameter reflecting received signal level in a cell/sector where the transmitter is camping or being served; and
signal level in a co-sited cell/sector, the respective parameter determining direction from stored assisting position data; and
storage means for storing of assisting position data in relation to the at least one parameter.

18. The device according to claim 17 wherein the assisting position data is classified in intervals of one or more parameters.

19. The device according to claim 18 further comprising processing means for averaging position data in each interval over the interval of each of the one or more parameters.

20. The device according to claim 19 wherein the one or more parameters include received signal level.

21. The device according to claim 19 wherein the one or more parameters include timing advance.

22. The device according to claim 19 wherein the stored assisting position data is average position data.

23. The device according to claim 17 wherein the assisting position data is GPS or other satellite positioning system position data.

24. The device according to claim 17, wherein for a public mobile radio communication system with a plurality of subscriber receivers, the assisting position data is received from one or more subscriber receivers.

25. The device according to claim 17 wherein the co-sited cell/sector is at least one of the cells/sectors being immediate neighbors of the cell where the transmitter is camping or being served.

26. The device according to claim 17 wherein direction to the transmitter is determined by forming a ratio of the neighbor cell/sector received level and received level of cell/sector where the transmitter is camping or being served.

27. The device according to claim 17 wherein the processing means further comprises including cell/sector identity determination of transmitter positioning.

28. The device according to claim 17 wherein the processing means further comprises forming a time average of received signal level prior to forming a basis for positioning.

29. The device according to claim 28 wherein the time average is formed in a network control element.

30. The device according to claim 29 wherein the network control element is an entity most closely connected to the receiver entity over a standardized interface.

31. The device according to claim 30 wherein the entity most closely connected to the receiver is a base station controller.

32. The device according to claim 30 wherein the entity most closely connected to the receiver is a radio network controller.

33-34. (canceled)
